(19) United States
(12) Patent Application Publication
(10) Pub. No.: US 2020/0191451 A1
(43) Pub. Date: Jun. 18, 2020

(54) Thermally Insulated Receptacle

(71) Applicants: LIEBHERR-HAUSGERATE OCHSENHAUSEN GMBH, Ochsenhausen (DE); LIEBHERR-HAUSGERATE LIENZ GMBH, Lienz (AT)

(72) Inventors: Jochen Hiemeyer, Karlstadt (DE); Michael Freitag, Wurzburg (DE); Martin Kerstner, Wurzburg (DE)

(73) Assignees: LIEBHERR-HAUSGERATE OCHSENHAUSEN GMBH, Ochsenhausen (DE); LIEBHERR-HAUSGERATE LIENZ GMBH, Lienz (AT)

(21) Appl. No.: 16/801,617

(22) Filed: Feb. 26, 2020

Related U.S. Application Data
(62) Division of application No. 15/318,985, filed on Dec. 15, 2016.

(30) Foreign Application Priority Data
Jun. 16, 2014 (DE) 10 2014 008 668.2

(51) Int. Cl. F25B 21/04; F25B 21/02; F28D 15/02; F25D 11/02; F25B 49/00

(52) U.S. Cl. CPC F25B 21/04; F25B 21/02; F28D 15/02; F25D 11/02; F25D 2201/14; Y02B 40/34; F25B 2321/023; F25B 2321/0251; F25B 49/00

(57) ABSTRACT

The invention relates to a thermally insulated receptacle, preferably a refrigeration and/or a freezing appliance, comprising at least one temperature-controlled, preferably chilled interior and at least one thermoelectric element (20), especially at least one Peltier element (20), for controlling the temperature in the interior, preferably for generating cold in the chilled interior; further comprising at least one solid (10, 12) which is disposed in such a way that heat is conducted to the thermoelectric element (20), especially heat is dissipated from the chilled interior to the thermoelectric element (20) and/or heat is dissipated from the thermoelectric element (20) by having the solid (10, 12) conduct heat.

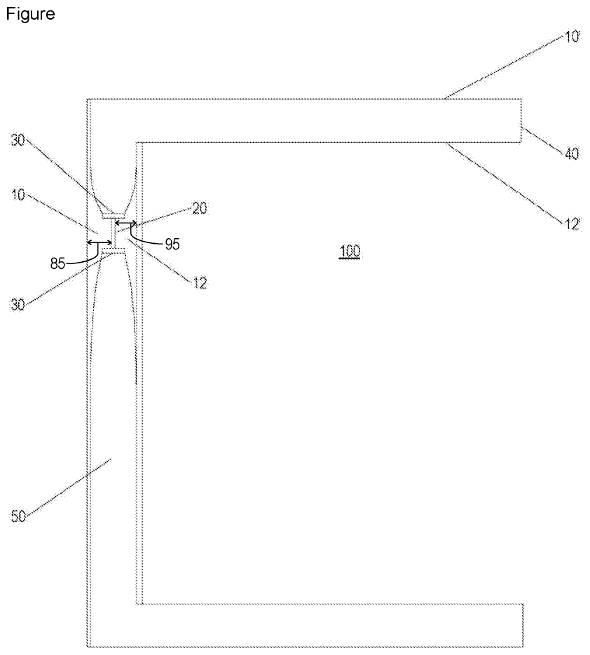

The present invention relates to a thermally insulated container, preferably a refrigerator unit and/or freezer unit having at least one preferably cooled inner space and having at least one thermoelectric element, in particular having at least one Peltier element, for the temperature control of the inner space, preferably for generating cold in the cooled inner space.

Different concepts are known from the prior art for cold production in refrigerator units and freezer units. In all cases, an effective heat exchanger is required both on the refrigerating space side and on the waste heat side for an efficiency which is as high as possible, and thus for good energy efficiency, to keep the temperature difference to be overcome as small as possible. In this connection, the coupling to the region of the cold production and to the refrigerating space as well as to the outside air to which the discharged air is output is of importance.

In customary compression refrigeration machines, both static systems, i.e. static evaporators and condensers, and dynamic systems such as no-frost evaporators, no-frost fans or block condensers having forced convection are used for the coupling to the inner space and to the outside air. In dynamic systems, the advantage based on the achievable small temperature difference is opposed by the additional effort for the mass transport for the convection of the air.

A major parameter in the required refrigeration capacity of a refrigerator unit or freezer unit is the thermal insulation which surrounds the cooled inner space. If the thermal insulation is improved, the requirement for refrigeration capacity is reduced. With a small refrigeration requirement, the provision can take place by simpler means than by compression refrigeration machines, namely in particular by thermoelectric elements. The use of Peltier elements is known, for example. A small refrigerator unit insulated by vacuum insulation thus, for example, only requires a refrigeration capacity of 3-4 W which can e.g. be produced by a thermoelectric element.

There is a special feature in the use of Peltier elements in that the refrigeration capacity produced and the waste heat occur in direct spatial proximity—a refrigerant as a heat carrier is not present. In this case, the heat transfer to the cooled inner space as well as to the outside air to which the heat is output is of special importance. It is known from the prior art to improve this heat transfer in Peltier refrigerator units such as portable coolers by ribbed recuperators and by an air flow produced by fans. Their power requirement is at a similar order of magnitude to that of the Peltier element.

These considerations are, however, by no means restricted to refrigerator units and/or freezer units, but also apply to thermally insulated containers in general.

The thermally insulated container has at least one temperature-controlled inner space, with this being able to be cooled or heated so that a temperature results in the inner space below or above the ambient temperature of e.g. 21° C.

It is the underlying object of the present invention to further develop a thermally insulated container, preferably a refrigerator unit and/or a freezer unit of the initially named kind, such that the heat transport is improved with respect to known containers, preferably units.

This object is achieved by a thermally insulated container, in particular a refrigerator unit and/or a freezer unit having the features of claim 1. At least one solid body is accordingly present which is arranged such that the conduction of heat to the thermoelectric element, in particular the leading off of heat from the cooled inner space to the thermoelectric element and/or the leading off of heat away from the thermoelectric element takes/take place by means of the solid body.

The solid body is thus configured and arranged such that a conduction of heat to the thermoelectric element by means of the solid body, in particular a heat dissipation from the cooled inner space to the thermoelectric element and/or a heat dissipation from the thermoelectric element preferably takes place at a heat sink and preferably to the ambient atmosphere of the container, preferably a unit. The heat transport preferably takes place only by thermal conduction through the solid body.

Provision is made in a further conceivable embodiment of the invention that at least one liquid heat exchanger and/or at least one heat pipe is provided which is/are arranged such that it/they conducts/conduct heat to the thermoelectric element, in particular from the cooled inner space to the thermoelectric element, and/or dissipates/dissipate heat from the thermoelectric element.

A “liquid heat exchanger” is to be understood as a heat exchanger which works with a liquid heat carrier medium. The advantage results with respect to air heat exchangers of a higher thermal capacity and a lower flow loss. A “heat pipe” is a tubular body which is filled with a refrigerant, at whose hot end the refrigerant evaporates and at whose cold end the refrigerant condenses, whereby the evaporation enthalpy is output.

This embodiment of the invention provides that a heat transport, in particular the transport of the waste heat from the cooled inner space, takes place by means of at least one liquid heat exchanger and/or by means of at least one heat pipe.

A distribution of the small heat flows to the environment with a minimal temperature difference is possible by means of the heat transport mechanisms in accordance with the invention.

It is conceivable that the solid body or the liquid heat exchanger and/or the heat pipe transports/transport heat in a good thermal coupling from the inner wall of the preferably cooled inner space to the thermoelectric element and/or from the latter to the outer skin of the container, preferably a unit.

The heat transport from the preferably cooled inner space to the inner wall and/or the heat transport to the outer skin preferably takes place from the outer skin to the environment of the container, preferably a unit, preferably statically, i.e. without forced convection.

A combination of the two aforesaid concepts is also conceivable, i.e. that in particular or only in the region of the greatest heat flow densities at the thermoelectric element, a support of the solid body thermal conduction takes place by the heat transport by means of a heat pipe and/or a liquid heat exchanger or, vice versa, a support of the heat transport through the heat pipe and/or liquid heat exchanger takes place through the solid body heat conduction.

The container, in particular the refrigerator unit and/or the freezer unit in accordance with claim 1 can thus be configured with the features in accordance with claim 2.

Provision is made in a preferred embodiment of the invention that the solid body is thermoconductively connected to the outer skin of the container, preferably of the unit, and/or is connected to the inner wall of the container, preferably of the unit, or partly or completely forms the outer skin and/or the outer wall bounding the cooled inner space.

The solid body preferably comprises metal or consists thereof, with aluminum forming a preferred embodiment of the metal.

It is conceivable that heat from the thermoelectric element is conducted by an aluminum metal structure or another metal structure onto the outer housing surface and/or from the inner surface which bounds the cooled inner space through an aluminum structure or another metal structure to the thermoelectric element. In this respect, the shape of the metal structure is preferably adapted such that the temperature drop in the incident heat flows is distributed over the surface such that it only amounts to a few degrees Kelvin between the location of the heat pump, i.e. the thermoelectric element, and the respective surface.

The metal structure, i.e. the named solid body, preferably partly or completely forms the outer skin and/or the inner wall of the container, preferably of the unit.

Provision is preferably made that the container, preferably the refrigerator unit and/or the freezer unit, only or also has a vacuum insulation as a thermal insulation of the cooled inner space. A vacuum insulation, for example by means of vacuum insulation panels or by means of evacuated housing walls and/or by means of an evacuated closing element, in particular of a door or lid for closing the cooled inner space, forms a particularly effective thermal insulation so that a comparatively small capacity, preferably a refrigeration capacity, is sufficient in operation to obtain the desired temperature.

An embodiment is particularly preferred in which a thermal insulation is arranged between the inner wall bounding the inner space and the outer skin and comprises a full vacuum system. A thermal insulation is to be understood by this which comprises only or primarily an evacuated region which is filled with a core material. The bounding of this region can be formed, for example, by a vacuum-tight film and preferably by a high barrier film. Only such a film body can thus be present between the inner wall of the container, preferably of the unit, and the outer skin of the container, preferably of the unit, as the thermal insulation which has a region which is surrounded by a vacuum-tight film, in which there is a vacuum and in which a core material is arranged. A foaming and/or vacuum insulation panels are preferably not provided as thermal insulation or another thermal insulation is not provided, except for the full vacuum system between the inner side and the outer side of the container or unit.

This preferred form of thermal insulation in the form of a full vacuum system can extend between the wall bounding the inner space and the outer skin of the carcass and/or between the inner side and the outer side of the closing element such as a door, flap, lid, or the like.

The full vacuum system can be obtained such that an envelope of a gas-tight film is filled with a core material and is subsequently sealed in a gas-tight manner. In an embodiment, both the filling and the vacuum-tight sealing of the envelope take place at normal or ambient pressure. The evacuation then takes place by the connection to a vacuum pump of a suitable interface worked into the envelope, for example an evacuation stub which can have a valve. Normal or ambient pressure is preferably present outside the envelope during the evacuation. In this embodiment, it is preferably not necessary at any time of the manufacture to introduce the envelope into a vacuum chamber. A vacuum chamber can be dispensed with in an embodiment to this extent during the manufacture of the vacuum insulation.

In a preferred embodiment of the invention, the thickness of the solid body increases toward the thermoelectric element. In the direction away from the thermoelectric element, the thickness of the solid can reduce and its areal extent can in turn increase.

Provision can furthermore be made that at least one fastening apparatus, preferably at least one clamping body, is present which fixes the solid body and/or the liquid heat exchanger and/or the heat pipe to the thermoelectric element, with provision preferably being made that the fastening apparatus has a smaller thermal conductivity than the solid body. The fastening apparatus can comprise plastic, for example.

As stated above, a preferred embodiment of the invention comprises the solid body consisting of aluminum or comprising aluminum.

At least one latent heat accumulator can be provided to be able to provide additional heating capacity or refrigerating capacity on the loading with hot or cold goods. It can be arranged at the useful space side, preferably at the surface of the inner wall at the refrigerating space side. It takes up heat from the temperature-controlled inner space or outputs heat into the temperature-controlled inner space and thereby supports the thermoelectric element.

The temperature-controlled inner space is either cooled or heated depending on the type of the unit (cooling appliance, heating cabinet, etc.).

Provision is preferably made that the latent heat accumulator is thermoconductively connected to the solid body and/or to the liquid heat exchanger and/or to the heat pipe.

The latent heat accumulator can consist of paraffin or comprise paraffin, for example.

Provision is made in a further embodiment of the invention that the container is a refrigerator unit and/or a freezer unit and that the solid body or the inner wall of the unit is configured such that a smaller temperature results at at least one position at the surface of the solid body or the inner wall than in other regions of the surface of the solid body or of the inner wall and that means for dissipating the condensation arising there are provided.

Provision is made in an embodiment that the container in accordance with the invention is a refrigerator unit and/or a freezer unit, in particular a domestic appliance or a commercial refrigerator unit. Such units are, for example, covered which are designed for a stationary arrangement at a home, in a hotel room, in a commercial kitchen or in a bar. It can, for example, be a wine cooler. Chest refrigerators and/or freezers are furthermore also covered by the invention. The units in accordance with the invention can have an interface for connection to a power supply, in particular to a domestic mains supply (e.g. a plug) and can have a standing aid or installation aid such as adjustment feet or an interface for fixing within a furniture niche. The unit can, for example, be a built-in unit or also a stand-alone unit.

In an embodiment, the container or the unit is configured such that it can be operated at an AC voltage such as a domestic mains voltage of e.g. 120 V and 60 Hz or of 230 V and 50 Hz. In an alternative embodiment, the container or the unit is configured such that it can be operated with DC current of a voltage of, for example, 5 V, 12 V or 24 V. Provision can be made in this embodiment that a plug-in power supply is provided inside or outside the unit via which the unit is operated. An advantage of the use of thermoelectric heat pumps in this embodiment is that the whole EMC problem only occurs at the power pack.

Provision can in particular be made that the refrigerator unit and/or freezer unit has a cabinet-type design and has a useful space which is accessible to a user at its front side (at the upper side in the case of a chest). The useful space can be divided into a plurality of compartments which are all operated at the same temperature or at different temperatures. Alternatively, only one compartment can be provided. Storage aids such as trays, drawers or bottle-holders (also dividers in the case of a chest) can also be provided within the useful space or within a compartment to ensure an ideal storage of refrigerated goods or frozen goods and an ideal use of the space.

The useful space can be closed by at least one door pivotable about a vertical axis. In the case of a chest, a lid pivotable about a horizontal axis or a sliding cover is conceivable as the closing element. The door or another closing element can be connected in a substantially airtight manner to the carcass by a peripheral magnetic seal in the closed state. The door or another closing element is preferably also thermally insulated, with the thermal insulation being able to be achieved by a foaming and optionally by vacuum insulation panels or also preferably by a vacuum system and particularly preferably by a full vacuum system. Door storage areas can optionally be provided at the inside of the door in order also to be able to store refrigerated goods there.

It can be a small appliance in an embodiment. In such units, the useful space defined by the inner wall of the container has, for example, a volume of less than 0.5 m³, less than 0.4 m³ or less than 0.3 m³.

The outer dimensions of the container or unit are preferably in the range up to 1 m with respect to the height, width and depth.

The invention is, however, not restricted to refrigerator units and/or freezer units, but rather generally applies to units having a temperature-controlled inner space, for example also to heat cabinets or heat chests.

In the case of a container or unit having a heated inner space, a thermal conduction takes place from the environment or from the outer skin of the container by means of the solid body to the thermoelectric element and from it by means of a solid body through heat conduction to the inner space or to the inner wall of the container bounding the inner space.

Further details and advantages of the invention will be explained in more detail with reference to an embodiment shown in the drawing.

The only Figure shows a cross-sectional view through a refrigerating unit in accordance with the invention.

The Figure shows by the reference numerals 10′, 12′ the housing wall which comprises aluminum, which forms the outer surface contacting the environment and the inner surface of the cooled inner space.

A Peltier element is marked by reference numeral 20 whose cold region is in thermoconductive connection with the aluminum solid body 12 and whose hot region is in thermoconductive connection with the aluminum solid body 10.

As can be seen from the Figure, the thickness 85 and 95, i.e. the extent of the bodies 10, 12 perpendicular to the outside and inside of the unit, increases toward the Peltier element 20.

The areal extent of the bodies 10, 12 in a direction in parallel with the outside and the inside, in contrast, decreases from the outside and from the inside toward the Peltier element.

Reference numeral 30 denotes a clamping apparatus which fixes the bodies 10, 12 to the Peltier element 20.

Reference numeral 40 denotes the door seal and the labyrinth in a simplified representation. The unit door is not shown.

The vacuum insulation which extends between the inner wall 12′ and the outer wall 10′ is marked by the reference numeral 50. The comparatively small thermal capacity by the Peltier element 20 is sufficient for cooling the inner space 100 due to the small heat input through the vacuum insulation.

In the event that a larger amount of hot cooling goods is introduced, a latent heat accumulator is provided such as paraffin which supports the refrigeration capacity of the unit in this case.

As can furthermore be seen from the Figure, the solid bodies 10, 12, which are thermoconductively connected to the Peltier element 20, not only form the “heat transport means”, but also simultaneously the inner wall 12′ and the outer wall 10′ of the unit.

The heat transfer to the inner wall 12′ and from the outer wall 10′ preferably takes place statically, i.e. without the use of fans, whereby a corresponding energy saving results.

In the embodiment drawn in the Figure, the heat transport takes place from the inside to the outside only through the solid bodies 10, 12. However, the use of one or more liquid heat exchangers and/or heat pipes for the heat transport is also covered by the invention. They can be used alternatively or in addition to the named solid body thermal conduction.

1-11. (canceled)

12. A refrigerating unit, which is a refrigerator, a freezer or a refrigerator-freezer combination, the refrigerating unit comprising
a thermally insulated carcass enclosing an inner space; the thermally insulated carcass comprising an inner wall adjacent to the inner space, an outer skin forming the outside of the carcass and vacuum insulation elements arranged between the inner wall and the outer skin;
a Peltier element arranged to cool the inner space; and
solid heat conducting bodies on either side of the Peltier element, wherein an inner solid heat conducting body is present and arranged to transfer heat between the Peltier element and the inner wall and wherein an outer solid heat conducting body is arranged to transfer heat between the Peltier element and the outer skin;
and
wherein the inner solid heat conducting body and the inner wall of the carcass together form a single one-piece assembly, or wherein the outer solid heat conducting body and the outer skin of the carcass together form a single one-piece assembly or both.

13. The refrigerating unit in accordance with claim 12, wherein the inner solid heat conducting body, the outer solid heat conducting body, or both have a varying thickness and are thickest where in contact with the respective Peltier element.

14. The refrigerating unit in accordance with claim 12, further comprising a plastic fastening element to fix the inner solid heat conducting body, the outer solid heat conducting body or both to the Peltier element.

15. The refrigerating unit in accordance with claim 12, wherein the inner solid heat conducting body, the outer solid heat conducting body, or both consist of aluminum.
